(19) United States
(12) Patent Application Publication
(10) Pub. No.: US 2011/0266313 A1
(43) Pub. Date: Nov. 3, 2011

(54) HANDHELD ELECTRONIC DEVICE GRIP

(75) Inventors: Syed Naveed Ghalib, Revere, MA (US); Maheen Junaid, Revere, MA (US)

(73) Assignee: GHALIB, LLC, Revere, MA (US)

(21) Appl. No.: 12/772,346

(22) Filed: May 3, 2010

(51) Int. Cl. A45F 5/00; B23P 11/00

(52) U.S. Cl. 224/101; 29/428

(57) ABSTRACT

A handheld electronic device grip is provided. The handheld electronic device grip includes a loop and a mounting structure. The loop is configured to receive at least one finger of a user, and the mounting structure configured to attach the loop to at least one of a handheld electronic device and a handheld electronic device case. The mounting structure is also configured to orient the loop so that a central axis of an opening of the loop is generally transverse to a longitudinal direction of the handheld electronic device or the handheld electronic device case.

### BACKGROUND OF THE INVENTION

1. Field of Invention

At least one embodiment of the present invention relates generally to a handheld electronic device grip, and more specifically, to a system and method for securing a handheld electronic device grip with one hand.

2. Discussion of Related Art

Portable electronic devices contain extensive amounts of valuable and important data. These portable electronic devices rely on sensitive and fragile components and are made from materials that can be damaged if not handled with care. These portable electronic devices also come in different shapes and sizes, and have different weight balances. If dropped, portable electronic devices can break and data can be lost.

### SUMMARY OF THE INVENTION

Aspects and embodiments of the present invention are directed to a grip for a handheld electronic device, as well as systems and methods of attaching the grip to the handheld electronic device, and of using the grip. For example, the grip includes a loop that can be attached to the back side of a handheld electronic device. The loop extends from the back side of the handheld electronic device so that the user can secure the handheld electronic device with one hand by inserting at least one finger through the loop. By securing the handheld electronic device in this manner, the user can comfortably access the features of the handheld electronic device in a variety of ergonomic positions, such while lying down or walking. The user may also manipulate a user interface of the handheld electronic device with the thumb of the same hand that secures the handheld electronic device.

At least one aspect is directed to a handheld electronic device grip that includes a loop and a mounting structure. The loop is configured to receive at least one finger of a user. The mounting structure is configured to attach the loop to a handheld electronic device or a handheld electronic device case. The mounting structure orients the loop so that a central axis of an opening of the loop is generally transverse to a longitudinal direction of the handheld electronic device or its case.

At least one other aspect is directed to a handheld electronic device grip that includes means for configuring a loop to receive at least one finger of a user. The handheld electronic device grip also includes means for attaching the loop to a handheld electronic device or a handheld electronic device case, wherein a central axis of an opening of the loop is generally transverse to a longitudinal direction of the handheld electronic device or its case.

At least one other aspect is directed to a method of connecting a handheld electronic device grip to a handheld electronic device. The handheld electronic device grip includes a mounting structure and a loop. The method includes attaching the mounting structure to a handheld electronic device or a handheld electronic device case, and attaching the loop to the mounting structure. The method also includes orienting the loop so that a central axis of an opening of the loop is generally transverse to a longitudinal direction of the at least one of the handheld electronic device and the handheld electronic device case.

At least one other aspect is directed to a method of securing a handheld electronic device. The method includes providing a handheld electronic device grip that includes a loop and a mounting structure. The loop is configured to receive at least one finger of a user, and the mounting structure is configured to attach the loop to at least one of a handheld electronic device and a handheld electronic device case. The mounting structure is also configured to orient the loop so that a central axis of an opening of the loop is generally transverse to a longitudinal direction of the at least one of the handheld electronic device and the handheld electronic device case.

In some embodiments, the loop includes an outer surface and an inner surface. At least a first portion of the outer surface is configured to engage the mounting structure, and the inner surface is configured to receive at least one finger of the user. The central axis of the opening of the loop can be within 45 degrees of a perpendicular axis that is perpendicular to the longitudinal direction of the at least one of the handheld electronic device and the handheld electronic device case. The mounting structure may also include a first surface and a second surface. The first surface is configured to releasably adhere to the handheld electronic device or its case, and the second surface is configured to engage the first portion of the outer surface of the loop. The first surface of the mounting structure may also be configured to permanently adhere to the handheld electronic device or its case. The outer surface of the loop may include a first portion of a hook and loop fastener system, and the mounting structure includes a second portion of the hook and loop fastener system.

In some embodiments, the mounting structure includes a first mounting structure portion and a second mounting structure portion. The first mounting structure portion is configured for placement on a first portion of the hand held electronic device or its case, and the second mounting structure portion is configured for placement on a second portion of the hand held electronic device or its case. The first mounting structure portion can be configured for placement adjacent to the second mounting structure portion, or distal to the second mounting structure portion.

The loop may also include a first loop configured to attach to the first mounting structure portion, and the handheld electronic device grip may include a second loop configured to attach to the first mounting structure portion or to a second mounting structure portion. In one embodiment, the second loop is configured to attach to a second mounting structure. The first and second loops may be configured to receive the same finger of the user, or the first loop can be configured to receive at least one first finger, with the second loop configured to receive at least one second finger of the same hand as the first finger. The second loop may have an inner surface and an outer surface, with a first portion of the outer surface of the second loop configured to attach to the mounting structure.

In some embodiments, the mounting structure is at least one of a rectangular shape, a quadrilateral shape, a polygonal shape, an equilateral shape, an asymmetrical shape, and an elliptical shape. The loop may include at least one of an elastic loop, a collapsible loop, a spring mounted loop, a rigid loop, a cloth loop, a cylinder, an oval, an ellipse, a tube, a sleeve, and a strap. The loop can have a diameter of less than 2 cm and a longitudinal length of at least 1 mm. In one embodiment, the loop is configured on the mounting structure as an ellipse having a major axis of less than 12 cm and a minor axis of less than 6 cm when the at least one finger is positioned in the opening of the loop. An inner surface of the loop may include concave grooves extending longitudinally along the central axis of the opening of the loop configured to accommodate at least finger disposed in the loop.

The loop may be configured substantially in parallel with a longitudinal axis of the handheld electronic device, with the opening of the loop having a central axis that is substantially perpendicular to the longitudinal axis of the handheld electronic device. The loop may also be configured to pivot between a first position parallel to the longitudinal axis of the handheld electronic device and a second position parallel to the longitudinal axis of the handheld electronic device. The loop may be an integral part of the mounting structure. In one embodiment, at least one of the loop and the mounting structure form part of the handheld electronic device case. The loop may be configured to position a hand of the user so that a thumb of the hand is positioned to manipulate substantially all of a user interface of the handheld electronic device when the at least one finger is positioned in the loop. The handheld electronic device grip can be configured to releasably or permanently attach to the handheld electronic device or its case.

Some embodiments include providing instructions to assemble the handheld electronic device grip. The instructions may direct a user to attach the mounting structure to at least one of the handheld electronic device and the handheld electronic device case. The instructions may also direct a user to attach the loop to the mounting structure. The instructions may also direct a user to orient the loop so that the central axis of the opening of the loop is generally transverse to the longitudinal direction of the at least one of the handheld electronic device and the handheld electronic device case.

Other aspects and embodiments are discussed in detail below. Both the foregoing information and the following detailed description are illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain the described and claimed aspects and embodiments.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a top view depicting a handheld electronic device grip in accordance with an embodiment;

FIG. 2 is a top view depicting a handheld electronic device grip in accordance with an embodiment;

FIG. 3 is a top view depicting a handheld electronic device grip in accordance with an embodiment;

FIG. 4 is a top view depicting a handheld electronic device grip in accordance with an embodiment;

FIG. 5 is a top view depicting a handheld electronic device grip in accordance with an embodiment;

FIG. 6 is a top view depicting a handheld electronic device grip in accordance with an embodiment;

FIG. 7 is a side view depicting a handheld electronic device grip in accordance with an embodiment;

FIG. 8 is a top view depicting a handheld electronic device grip in accordance with an embodiment;

FIG. 9 is a top view depicting a handheld electronic device grip in accordance with an embodiment;

FIG. 9A is a front plan view depicting a handheld electronic device grip in accordance with an embodiment;

FIG. 9B is a right side view depicting a handheld electronic device grip in accordance with an embodiment;

FIG. 9C is a bottom side view depicting a handheld electronic device grip in accordance with an embodiment;

FIG. 9D is a perspective view depicting a handheld electronic device grip in accordance with an embodiment;

FIG. 10 is a top view depicting a handheld electronic device grip in accordance with an embodiment;

FIG. 11 is a top view depicting a handheld electronic device grip in accordance with an embodiment;

FIG. 12 is a top view depicting a handheld electronic device grip in accordance with an embodiment;

FIG. 13 is a top view depicting a handheld electronic device grip in accordance with an embodiment;

FIG. 14 is a top view depicting a handheld electronic device grip in accordance with an embodiment;

FIG. 15 is a top view depicting a plurality of mounting structures of a handheld electronic device grip in accordance with an embodiment;

FIG. 16 is a flow chart depicting a method of connecting a handheld electronic device grip with a handheld electronic device in accordance with an embodiment; and

FIG. 17 is a flow chart depicting a method of connecting a handheld electronic device grip with a handheld electronic device in accordance with an embodiment.

### DETAILED DESCRIPTION

The systems and methods described herein are not limited in their application to the details of construction and the arrangement of components set forth in the description or illustrated in the drawings. The invention is capable of other embodiments and of being practiced or of being carried out in various ways. Also, the phraseology and terminology used herein is for the purpose of description and should not be regarded as limiting. The use of “including” “comprising” “having” “containing” “involving” and variations thereof herein, is meant to encompass the items listed thereafter, equivalents thereof, and additional items, as well as alternate embodiments consisting of the items listed thereafter exclusively.

Aspects and embodiments are directed to a handheld electronic device grip and methods for manufacturing, using, and attaching the same to a handheld electronic device. The handheld electronic device grip includes a loop, and is attached to the back side of the handheld electronic device with a mounting structure. The loop is positioned to receive at least one finger of the user. When the finger is positioned through the loop, the handheld electronic device is substantially secure, and a thumb of the same hand as the finger may be positioned to manipulate substantially all of a user interface on the front side of the handheld electronic device, leaving the user's other hand free. The user may then use the handheld electronic device in a variety of positions, such as while walking, using public transportation, trains, buses, airplanes taxis, cars, or while lying down, e.g., face down, face up, or on a side.

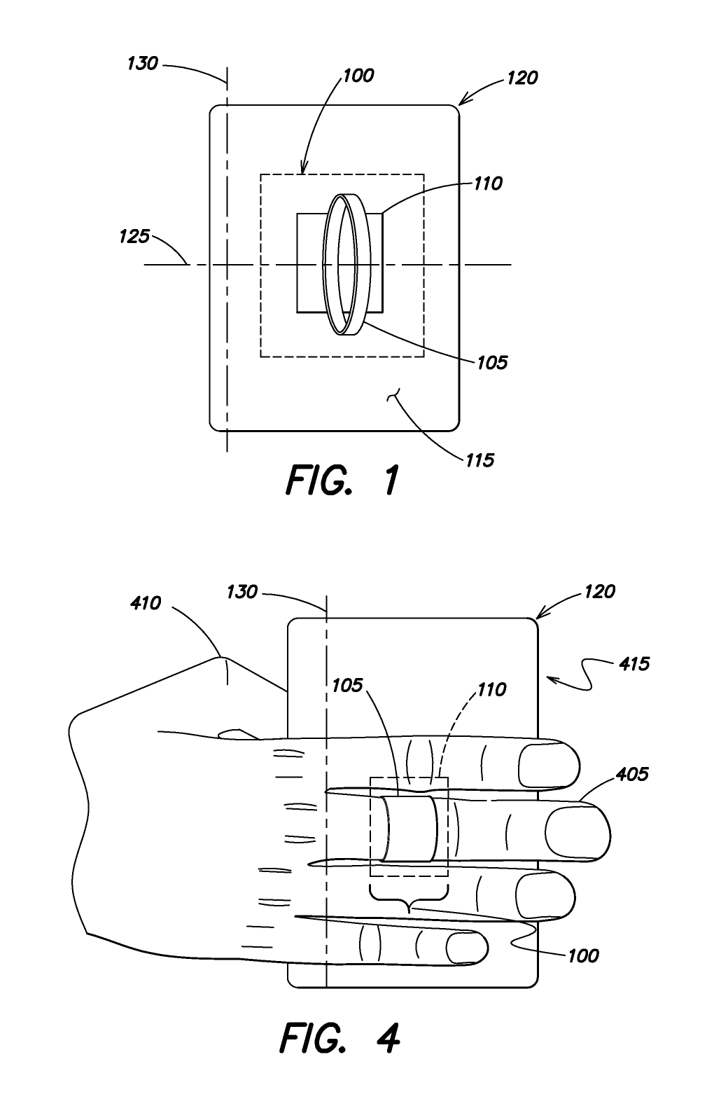

FIG. 1 is a top view depicting handheld electronic device grip 100. In one embodiment, handheld electronic device grip 100 includes loop 105 and mounting structure 110 as either a single unit, or as separate units that are reversibly or permanently attached to each other. Handheld electronic device grip 100 is configured to attach to back side 115 of handheld electronic device 120, which is the side of handheld electronic device 120 that is opposite to the user interface (not shown in FIG. 1) of handheld electronic device 120, such as a touch screen, keypad, trackball, or monitor. Handheld electronic device 120 includes a variety of devices with user interfaces that use electrical power, such as personal digital assistants, mobile telephones, portable music players, digital cameras, tablet computers, electronic book readers, video cameras, electronic communication devices, digital video devices, and gaming devices, for example. Handheld electronic device 120 may be a device larger or smaller than a user's hand, and includes devices configured for both one hand (e.g., mobile phone) and two hand (e.g., tablet computer) support.

In one embodiment, a first surface of mounting structure 110 is configured to attach to back side 115 of handheld electronic device 120 and a second surface of mounting structure is configured to attach to loop 105. The first surface of mounting structure 110 can also attach to a case (not shown in FIG. 1) that is secured to handheld electronic device 120 and covers at least a portion of back side 115. The case generally protects or adds ornamental or ergonomic features to handheld electronic device 120 while still allowing access to the user interface of handheld electronic device 120. In one embodiment, mounting structure 110 is an integral part of the case.

In some embodiments, mounting structure 110 when attached to handheld electronic device 120 may cover some (e.g., 5-95%), substantially all (e.g., greater than 95%), or substantially none (e.g., less than 5%) of back side 115. Mounting structure 110 is configured for placement anywhere on back side 115 of handheld electric device 120. For example, at least one mounting structure may be placed about the edges of back side 115, or in the central region of back side 115 distal from the edges. At least one mounting structure 110 can be placed symmetrically or asymmetrically on back side 115. In one embodiment, at least one mounting structure 110 is configured for placement anywhere on back side 115, and the user can determine where on back side 115 to attach mounting structure 110.

Mounting structure 110 may have a footprint on electronic device 120 that is greater than the footprint of loop 105. In this example, a user can affix mounting structure 110 in one position on electronic device 120, and can adjust the position of loop 105 on mounting structure 110 from a first position to a second position by repositioning loop 105 while mounting structure 110 remains fixed in its one position. In this example, mounting structure 110 may be permanently or temporarily fixed to electronic device 120.

Adhesive such as tape or glue can be applied to or exposed on at least a portion of a surface of mounting structure 110 or back side 115 to attach one side of mounting structure 110 with handheld electronic device 120, or its associated case. In some embodiments, rivets, mechanical fasteners, latches, hooks, friction fitting slots, clips, or other adherents may also be used to attach mounting structure 110 with handheld electronic device 120. These adherents may be permanent (e.g., glue) or releasable (e.g., mechanical fasteners).

In one embodiment, at least part of loop 105 and at least part of a surface of mounting structure 110 include a hook and loop fastener system so that loop 105 and mounting structure 110 engage when brought into contact. For example, a portion of an outer surface of loop 105 may include hooks (or, alternatively, loops or both) with at least some of mounting structure 110 having loops (or, alternatively, hooks or both). Loop 105 and mounting structure 110 may also employ adhesives, glues, or mechanical fasteners to connect loop 105 with mounting structure 110. In one embodiment, the connections between loop 105 and mounting structure 110, and between mounting structure 110 and handheld electronic device 120 are sufficient to overcome gravitational forces when handheld electronic device 120 is hanging from loop 105 in a pendant manner.

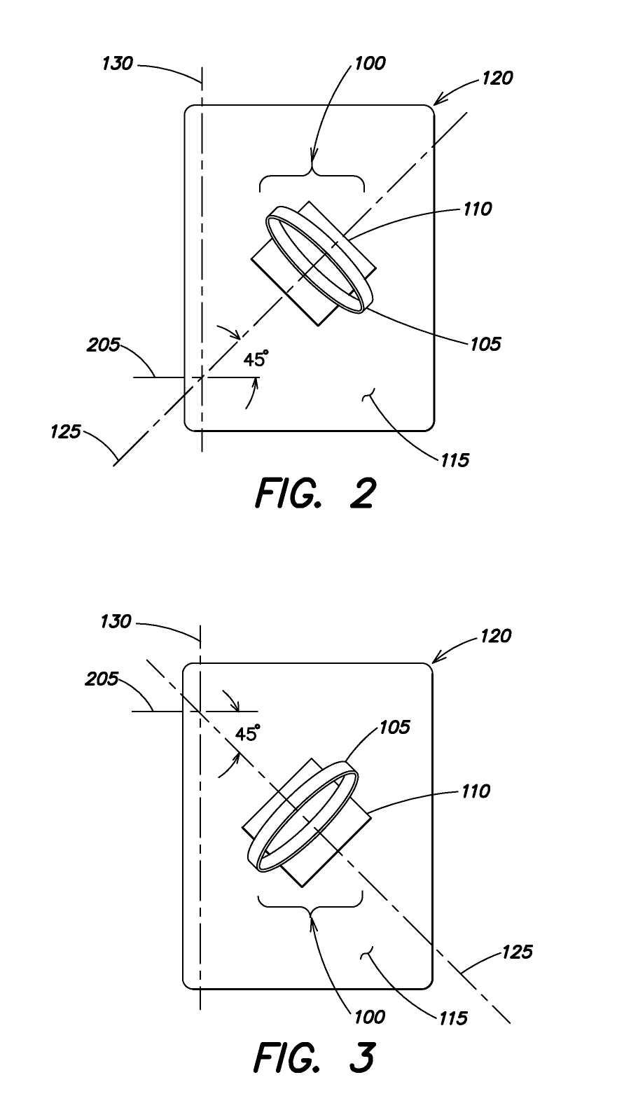

With reference to FIG. 1, loop 105 can attach to mounting structure 110 so that central axis 125 of an opening of loop 105 is generally transverse to longitudinal axis 130 of handheld electronic device 120. For example, central axis 125 and longitudinal axis 130 may intersect at approximately a 90 degree angle, as illustrated in FIG. 1. In some embodiments, central axis 125 is generally transverse to longitudinal axis 130 when central axis 125 and longitudinal axis 130 intersect within +/−45 degrees of a right angle, as illustrated in FIG. 2 and FIG. 3, which each depict an example top view embodiment of handheld electronic device grip 100. In one embodiment, the user may identify portions of mounting structure 110 and loop 105 that are configured to attach to each other. With reference to FIGS. 2 and 3, central axis 125 is within 45 degrees of perpendicular axis 205, which is the axis perpendicular to longitudinal axis 130. In one embodiment, loop 105 is configured to attach directly to handheld electronic device 120 or its case, for example, using an adhesive or clips, in the absence of mounting structure 110.

FIG. 4 is a top view depicting handheld electronic device grip 120 with loop 105 configured to receive at least one finger 405 of a user. As illustrated in FIG. 4, finger 405 extends through loop 105, contacting at least a portion of the inner surface of loop 105. In one embodiment, loop 105 is configured to receive at least one finger 405 in a generally snug and comfortable manner. For example, when finger 405 is positioned though the opening of loop 105, the handheld electronic device grip secures handheld electronic device 120 when the user otherwise releases his or her hold on handheld electronic device 120. In this example, handheld electronic device 120 does not fall to the ground and remains secured to the user's hand.

In one embodiment, loop 105 is configured to receive a plurality of fingers 405 of one hand of the user. For example, loop 105 can have the shape of an ellipse when a plurality of fingers 405 are disposed through its opening. In this example, the loop may have a major axis of less than 12 cm, and a minor axis of less than 6 cm when the plurality of fingers 405 are disposed in the opening of loop 105. In some embodiments when loop 105 is configured to receive a plurality of fingers 405, an inner surface of the loop may include concave grooves longitudinally extending in the direction of central axis 125 of the opening of loop 105 to align with the longitudinal axis of fingers 405 when the fingers 405 are disposed in the opening of loop 105. In one embodiment, each groove is sized to accommodate one finger 405.

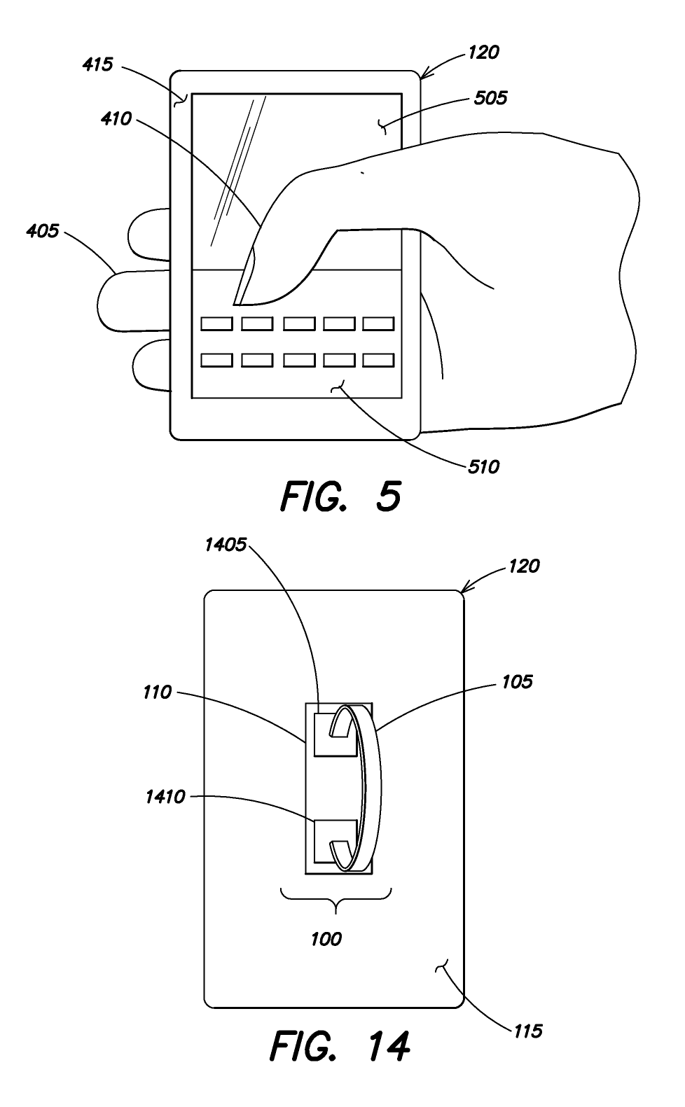

FIG. 5 is a top view depicting front side 415 of handheld electronic device grip 120. Front side 415 may include user interface 505, such as a touch screen, or keypad 510, which may include mechanical keys or a graphical display of keys as part of the touch screen.

With reference to FIGS. 4 and 5, loop 105 is configured to receive at least part of finger 405. For example, the user may position only the tip of finger 405 through the opening of loop 105 so that handheld electronic device 120 is centered about the user's fingertips. In another example, the user may insert substantially the entire finger 405 through the opening of loop 105 so that handheld electronic device 120 is centered deeper in the hand, closer to the palm. In one embodiment, when finger 405 is positioned in loop 105, the user's thumb 410 is positioned to contact front side 415 of handheld electronic device 120. In this configuration, thumb 410 can manipulate user interface 505 or other inputs of handheld electronic device 120. In this configuration, one hand of the user can simultaneously secure handheld electronic device 120 by disposing at least one finger 405 though loop 105, and thumb 410 of that same hand can manipulate user interface 505.

In one embodiment, loop 105 is made of a material having some elasticity. For example, loop 105 may include an elastic loop having a diameter of less than 1 cm (e.g., smaller than a finger diameter) when no finger is disposed through its opening. In this example, the diameter of loop 105 expands to accommodate a finger (e.g., greater than 1 cm) when the finger is inserted through the opening. In one embodiment, the longitudinal length of loop 105 is between 2 cm and about 4 cm. In some embodiments, this length is less than 2 cm and greater than 4 cm. Loop 105 may also be plastic, cloth, rigid, rubber, collapsible, or spring mounted. In one embodiment, the shape of the opening of loop 105 is generally curved so that when finger 405 is disposed through its opening, loop 105 generally forms at least one of a cylinder, oval, ellipse, tube, or sleeve shape. In one embodiment, loop 105 is configured as a strap to receive at least one finger 405. In one embodiment, loop 105 has a diameter that is less than either a length or a width of handheld electronic device 120. For example, loop 105 may have a diameter of less than 2 cm, and a longitudinal length of at least 1 mm. In one embodiment, loop 105 is in the shape of an ellipse with a major axis length that is substantially double a length of a minor axis when the at least one finger is disposed in the opening of loop 105.

Loop 105 can be made of a collapsible material (e.g., polyvinyl, cloth, or elastic material) that deforms when finger 405 is not disposed through its opening. For example, loop 105 may collapse onto mounting structure 110 or back side 115 due to gravitational forces when handheld electronic device 120 is placed on a table with back side 115 facing up and without finger 405 disposed through its opening. In this example, the collapsed loop 105 rests substantially flat on top of back side 115 and may loose its looped form in this configuration. In another example, loop 105 may collapse under the weight of handheld electronic device 120 and lie substantially flat when handheld electronic device 120 is placed on a table with back side 115 facing down (e.g., in contact with the table surface) and without finger 405 disposed through its opening. In one embodiment, loop 105 is removed from mounting structure 110 when not in use, and reattached to mounting structure 110 for subsequent use. When finger 405 is disposed in loop 105, that and other fingers of the user's hand may extend completely across back side 115 of handheld electronic device 120 as illustrated in FIG. 4, or they may extend only partially across back side 115 e.g., for larger handheld electronic devices 120 such as tablet computers or electronic book readers.

In one embodiment, loop 105 resists gravitational forces to maintain a generally circular form with a first diameter when no finger 405 is disposed therein and a second diameter when at least one finger 405 is disposed therein. The second diameter can be greater than the first diameter. For example, loop 105 may be elastic and in a contracted generally cylindrical form in the absence of finger 405. Loop 105 may expand to accommodate finger 405 when it is present in loop 105 in an expanded generally cylindrical form. In this example, loop 105 may resist gravitational forces and maintain a circular or cylindrical form when placed, for example, on a table with handheld electronic device grip 100 and backside 115 facing upward, and user interface 505 facing downward and generally in contact with a table surface. Continuing with this example, when handheld electronic device 100 is flipped over on the table so that user interface 505 is facing upward, loop 105 may at least partially contact the table surface and can at least partially collapse due to the weight of handheld electronic device 100.

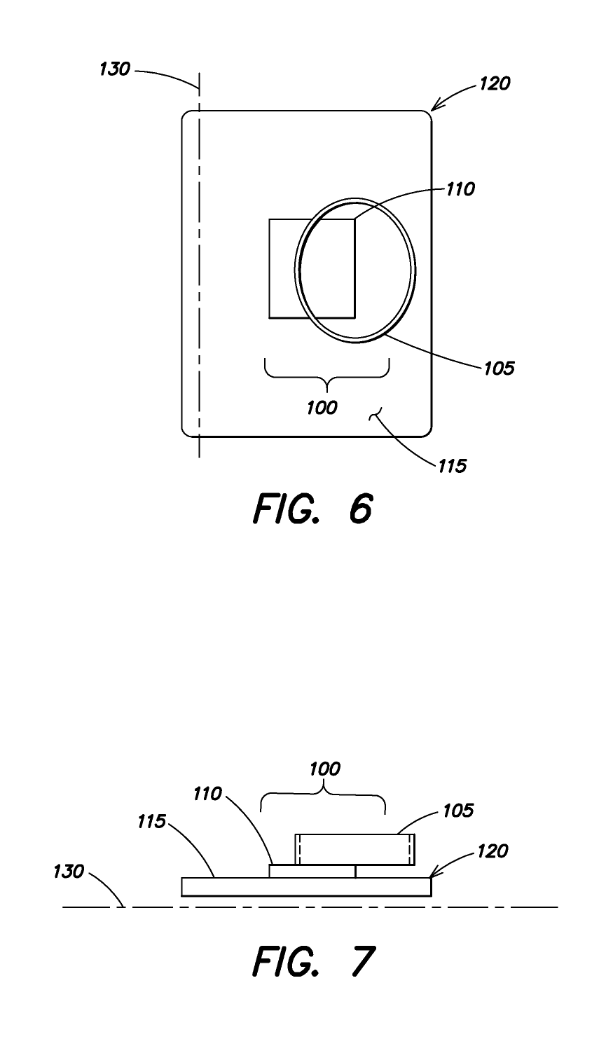

In one embodiment, loop 105 retains its form in the absence of finger 405. Loop 105 may be continuously curved or may be segmented with an octagonal or other segmented polygonal shape. Loop 105 may also be a rigid plastic or metal that can pivot with respect to mounting structure 110 to lie generally flat against back side 115, as illustrated in the top view of FIG. 6 and the side view of FIG. 7. With reference to FIGS. 6 and 7, loop 105 can pivot between first and second positions parallel to longitudinal axis 130.

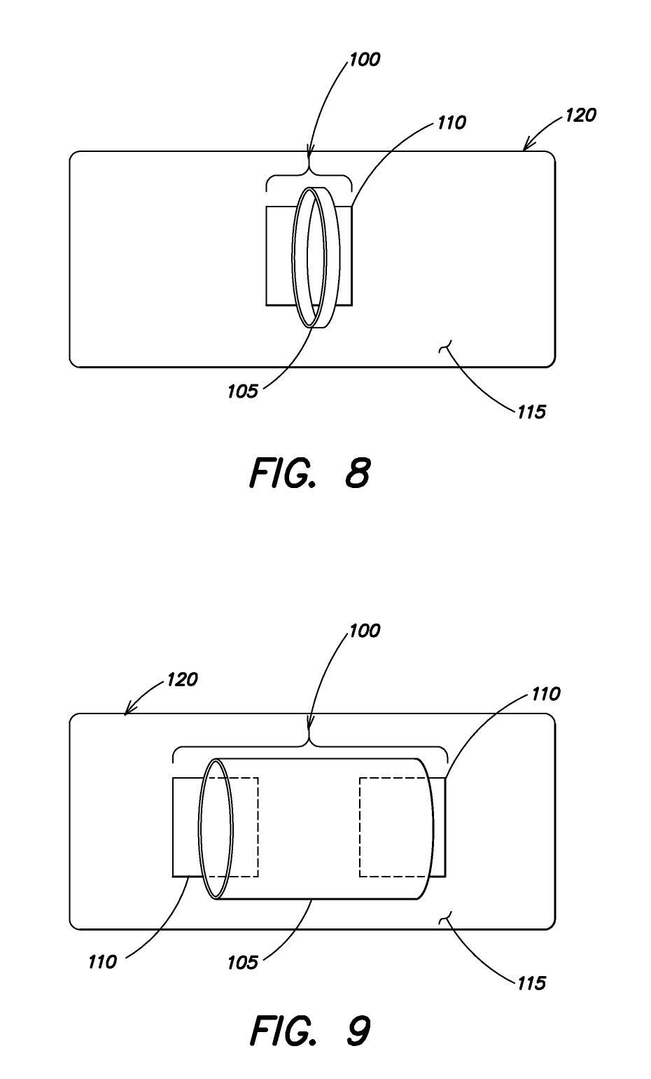

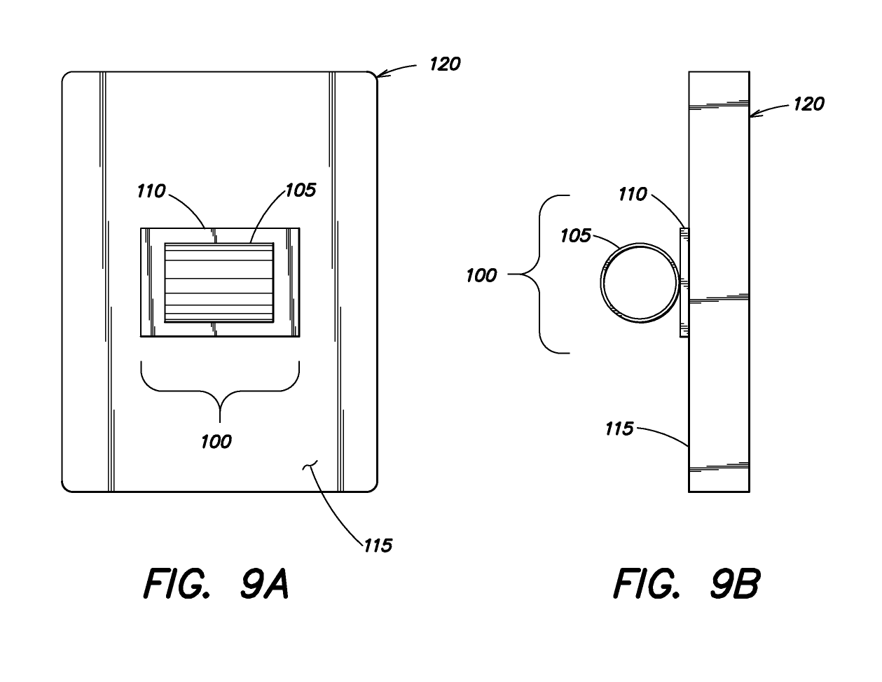

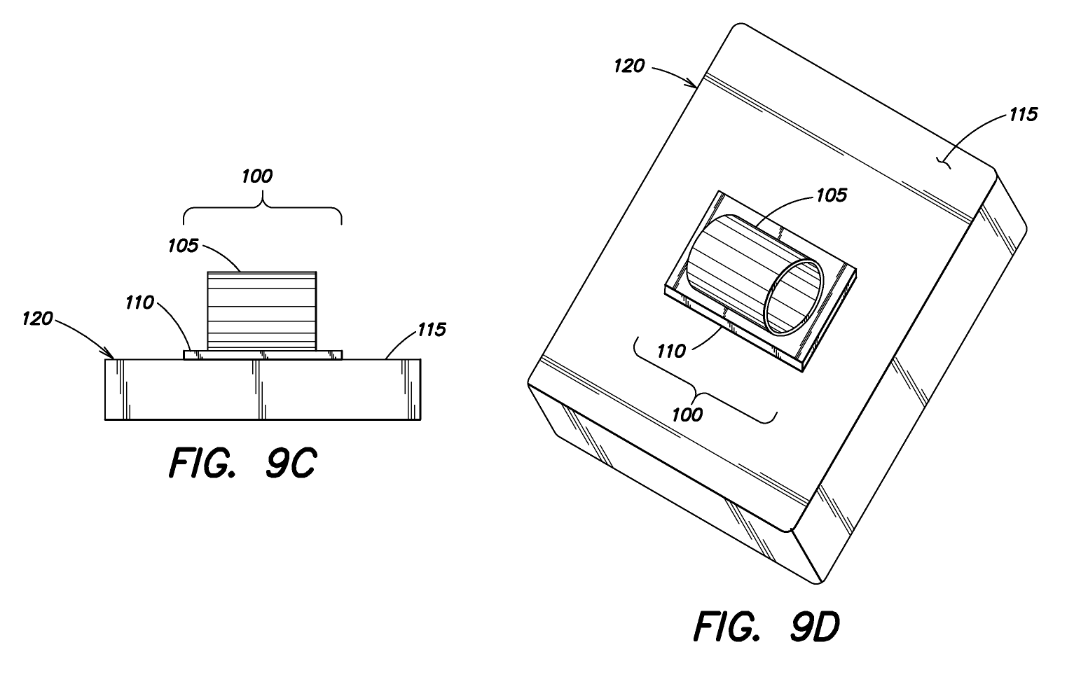

Further configurations of handheld electronic device grip 100 are illustrated in FIGS. 8-15. For example, FIG. 8 illustrates a handheld electronic device grip 100 configuration when handheld electronic device 120 is in a landscape configuration. FIG. 9 depicts an example handheld electronic device grip 100 configuration with loop 105 in the form of a cylinder configured to receive at least one finger. In the example of FIG. 9, two mounting structures 110 are positioned to attach loop 105 to back side 115. In one embodiment, at least one mounting structure 110 is configured to attach at least one loop 105 to handheld electronic device 120 or its case.

FIGS. 9A, 9B, 9C, and 9D depict examples of handheld electronic device grip 100 configuration with loop 105 in the form of a cylinder configured to receive at least one finger. In one embodiment, two or more fingers are disposed within loop 105. Loop 105 may include an elastic or cloth loop that at least partially collapses due, for example, to gravitational forces when no fingers are disposed in loop 105.

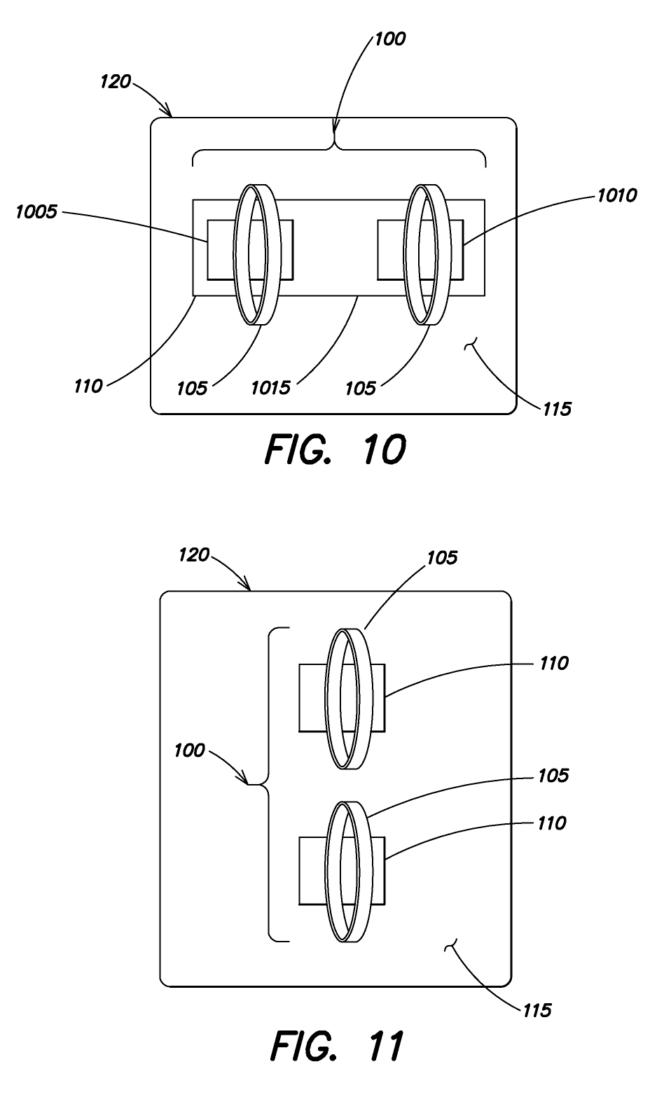

FIG. 10 depicts an example handheld electronic device grip 100 configuration. As illustrated in FIG. 10, mounting structure 110 includes first mounting structure portion 1005 and second mounting structure portion 1010. These two mounting structure portions, (1005 and 1010) may each attach at least one loop 105 with back side 115. In one embodiment, first mounting structure portion 1005 and second mounting structure portion 1010 each include fastening means for securing at least one loop 105, such as part of a hook and loop fastener system or the other adhesive or mechanical fasteners discussed herein. In this embodiment, remaining portion 1015 of mounting structure 110 is not configured to attach to loop 105. For example, remaining portion 1015 may include an ornamental design or logo, or may be camouflaged with back side 115. In one embodiment, not illustrated in FIG. 10, first mounting structure portion 1005 and second mounting structure portion 1010 collectively attach a single loop 105 with back side 115.

FIG. 11 depicts an example handheld electronic device grip 100 configuration with two loops 105, each loop 105 configured to receive at least one finger. These loops 105 may be mounted on different mounting structures 110 as illustrated in FIG. 11, or may be mounted on different portions of a single mounting structure 110 (not illustrated in FIG. 11).

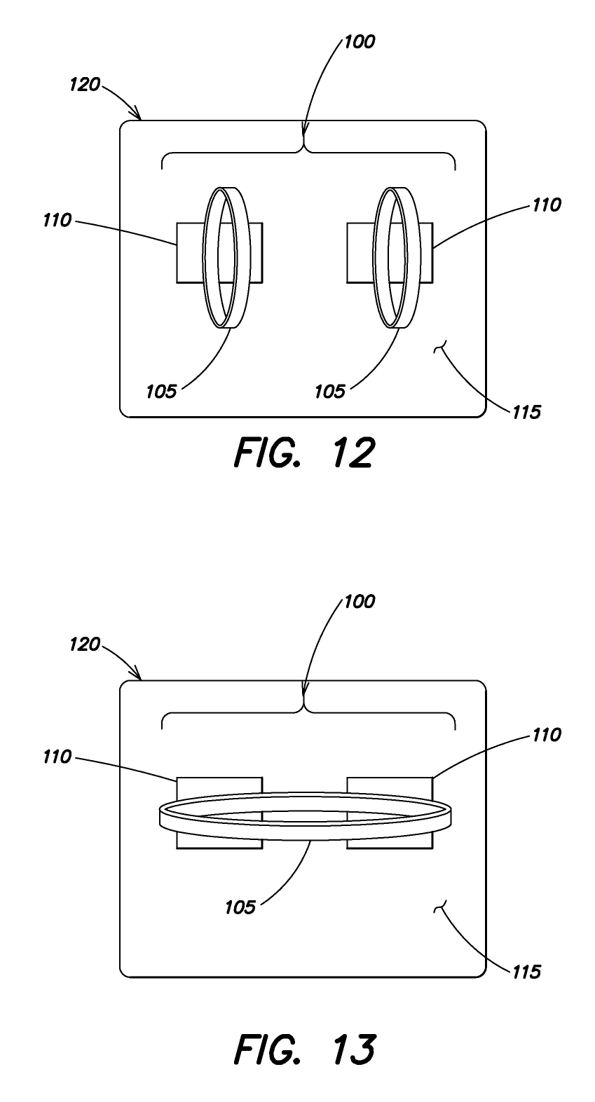

FIG. 12 depicts an example handheld electronic device grip 100 configuration with two loops 105 configured to receive a same finger or set of fingers of the user. FIG. 13 depicts an example handheld electronic device grip 100 configuration with one loop 105 configured to receive at least one finger and attached to back side 115 via two mounting structures 110.

FIG. 14 depicts an example handheld electronic device grip 100 configuration where loop 105 is an incomplete ring. With reference to FIG. 14, in one embodiment, mounting structure 110 completes the closed loop form of loop 105. For example, mounting structure can attach to loop 105 at first point 1405 and second point 1410. In one embodiment, back side 115 together with mounting structure 110 complete the closed loop form of loop 105.

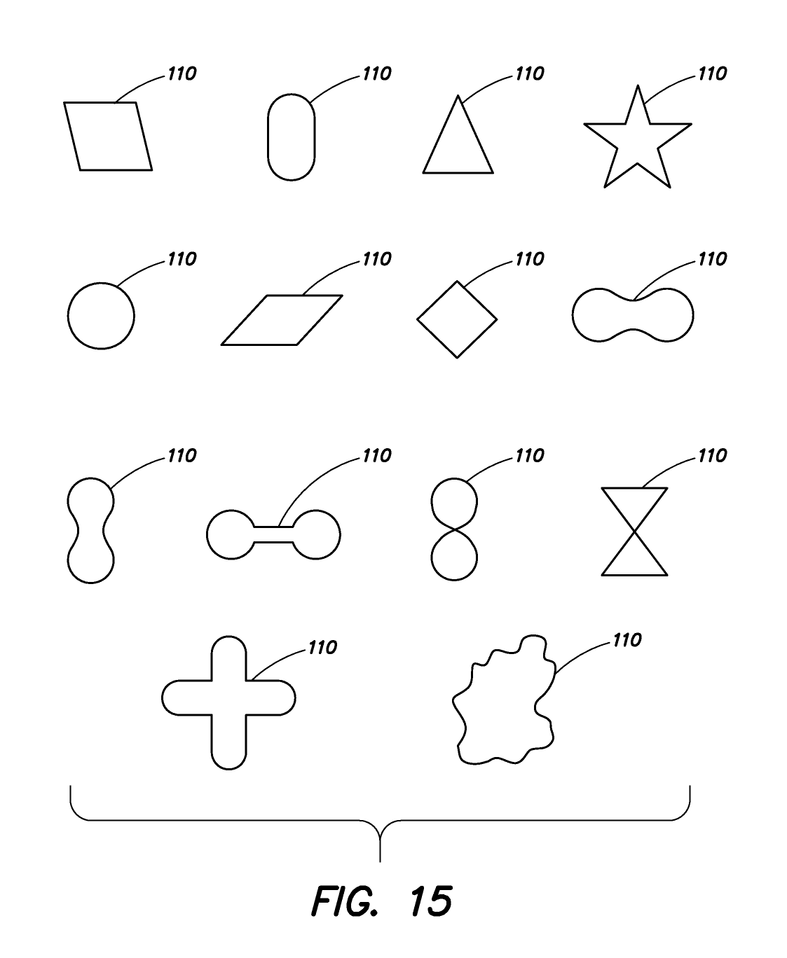

FIG. 15 depicts example mounting structure 110 shapes. One side of at least one mounting structure 110 can be configured to attach to handheld electronic device 120, or its case, and another side of mounting structure 110 can be configured to attach to loop 105. With reference to FIG. 15, mounting structure 110 can be generally square, elliptical, triangular, star shaped, circular, quadrilateral, diamond shaped, curved in the form of a peanut, curved in the form of a dumbbell, shaped as a FIG. 8, shaped as a double inverted triangle, or a cross with equal or unequal length arms, or a blob. Mounting structure 110 may have a symmetrical or asymmetrical shape, and may have the shape of numbers, letters, or names in either a block or stylized font.

With reference to FIGS. 1-15, handheld electronic device grip 100 secures handheld electronic device 120 when the user is in a variety of positions. By disposing at least one finger through the opening of loop 105, the user can securely grip handheld electronic device 120 with one hand. The positioning of at least one finger 405 through the opening of loop 105 on back side 115 of handheld electronic device 120 disposes thumb 410 of that same hand about front side 415 of handheld electronic device 120. Thumb 410 may then manipulate inputs of handheld electronic device 120. The second hand of the user is then free to focus on other activities. Further, the user can secure and manipulate handheld electronic device 120 with one hand in a variety of positions, such as in a supine position facing upwards with handheld electronic device 120 elevated above the face of the user, in a prone position, while walking, or using public transportation.

With continued reference to FIGS. 1-15, the relative sizes of loop 105, mounting structure 110, and handheld electronic device 120 are not necessarily to scale. For example, loop 105 with finger 405 disposed through its opening or in a collapsed position may or may not extend beyond the edges of mounting structure 110.

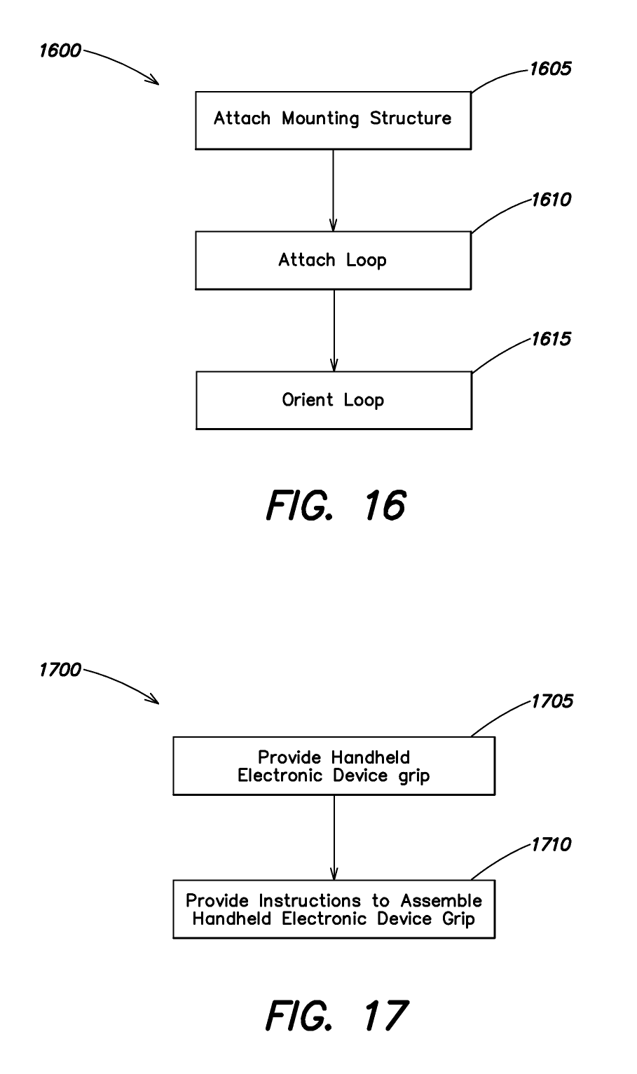

FIG. 16 is a flow chart depicting a method 1600 of connecting a handheld electronic device grip with a handheld electronic device in accordance with an embodiment. Method 1600 includes an act of attaching a mounting structure (ACT 1605). In one embodiment, attaching a mounting structure (ACT 1605) includes attaching a mounting structure to a handheld electronic device, its case, or both. For example, attaching a mounting structure (ACT 1605) may include releasably or permanently binding the mounting structure with the handheld electronic device or its case, using an adhesive such as glue or tape. Attaching a mounting structure (ACT 1605) may also include affixing the mounting structure to the handheld electronic device or its case using mechanical fasteners, clips, binders, screws, or joints. This may also include fitting the mounting structure into joints or slots of the handheld electrical device or its case.

Method 1600 may also include an act of attaching a loop to the mounting structure (ACT 1610). In one embodiment, attaching the loop (ACT 1610) includes releasably or permanently joining the loop to the mounting structure. For example, attaching a loop to the mounting structure (ACT 1610) may include hook and loop fasteners disposed on at least a portion of the loop and at least a portion of the mounting structure. Attaching a loop with the mounting structure (ACT 1610) may also include attaching the loop and the mounting structure with adhesives or mechanical linkages.

Method 1600 may also include an act of orienting the loop (ACT 1615). In one embodiment, the loop is oriented (ACT 1615) so that a central axis of an opening of the loop is generally transverse to a longitudinal direction of the handheld electronic device or its case. For example, orienting the loop (ACT 1615) may include orienting the loop to receive at least one finger of a user so that a thumb of the user is disposed near a user interface of the handheld electronic device when a finger of the same hand as the thumb is disposed in the loop. Orienting the loop (ACT 615) may include positioning the loop relative to at least one of the mounting structure, the handheld electronic device, and the handheld electronic device case, if any, so that a central axis of an opening of the loop is within 45 degrees of a perpendicular axis to the longitudinal direction of the at least one of the handheld electronic device or its case.

FIG. 17 is a flow chart depicting a method 1700 of connecting a handheld electronic device grip with a handheld electronic device in accordance with an embodiment. Method 1700 includes an act of providing a handheld electronic device grip (ACT 1705). In one embodiment, providing the handheld electronic device grip (ACT 1705) includes providing a device having a loop and a mounting structure. The loop is configured to receive at least one finger of a user, and the mounting structure is configured to attach to the loop and to attach to at least one of a handheld electronic device and its case, thus securing the loop to the handheld electronic device or its case. Providing the handheld electronic device grip (ACT 1705) may also include providing a grip with a loop configured so that a central axis of an opening of the loop is generally transverse to a longitudinal direction of the at least one of the handheld electronic device and its case.

Method 1700 may also include at least one act of providing instructions to assemble the handheld electronic device grip (ACT 1710). In one embodiment, providing instructions (ACT 1710) includes directing a user to attach the mounting structure to at least one of the handheld electronic device and its case. For example, providing instructions (ACT 1710) may include providing written instructions or illustrations to the user. These instructions can direct the user to attach the mounting structure with the handheld electronic device or its case, to attach the loop to the mounting structure, or to orient the loop so that the central axis of the opening of the loop is generally transverse to the longitudinal direction of the handheld electronic device or its case. Providing instructions to the user (ACT 1710) may also include directing the user to orient the central axis of the loop opening to within 45 degrees of a perpendicular axis to the longitudinal direction of the at least one of the handheld electronic device and its case.

In one embodiment, providing instructions to the user (ACT 1710) includes instructing the user to fasten the mounting structure to the handheld electronic device or its case, using for example an adhesive. Providing instructions to the user (ACT 1710) may also include directing the user to bring a portion of the outer surface of the loop into contact with a portion of the mounting structure to engage the loop with the mounting structure by connecting hook and loop fasteners, adhesive bonding, or mechanical linkages. In one embodiment, providing instructions to the user (ACT 1710) directs the user to position the mounting structure to orient the loop so that at least one finger may be disposed in an opening of the loop on the back side of the handheld electronic device, positioning the thumb of the same hand over the front side of the handheld electronic device, near a user interface or other inputs of the handheld electronic device.

In one embodiment, providing instructions (ACT 1710) includes the handheld electronic device executing an application to display instructions on its user interface to direct the user to attach the mounting structure to the handheld electronic device or its case, or to attach the loop to the mounting structure, or to orient the loop so that the central axis of the opening of the loop is generally transverse to the longitudinal direction of the handheld electronic device or its case.

Having now described some illustrative embodiments of the invention, it should be apparent to those skilled in the art that the foregoing is illustrative and not limiting, having been presented by way of example. In particular, although many of the examples presented herein involve specific combinations of method acts or system elements, it is understood that those acts and those elements may be combined in other ways to accomplish the same objectives. Acts, elements and features discussed only in connection with one embodiment are not intended to be excluded from a similar role in other embodiments.

Note that in FIGS. 1 through 17, the enumerated items are shown as individual elements. In actual implementations of the systems and methods described herein, however, they may be inseparable components of a single device. For example, the loop and the mounting structure may be part of a single device that forms the handheld electronic device grip. Further, the mounting structure may attach to all or part of a case, or be an integral part of the case, with the case connected to the handheld electronic device.

From the foregoing, it will be appreciated that the handheld electronic device grip described herein affords an effective way to secure a handheld electronic device with one hand, while ergonomically positioning the thumb of that hand within a contactable range of user interfaces or other inputs of the handheld electronic device. The handheld electronic device grip according to various embodiments is able to secure and operate the handheld electronic device with one hand when the user is in a variety of positions (e.g., lying down) and lets the user multi-task handheld electronic device operations with other user activity, such as walking or riding the subway. This allows for use of the handheld electronic device during times when, without the handheld electronic device grip, use of the handheld electronic device would otherwise be awkward or difficult.

Any references to front and back, left and right, top and bottom, or upper and lower, above and below, and the like are intended for convenience of description, not to limit the present systems and methods or their components to any one positional or spatial orientation.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations.

Any embodiment disclosed herein may be combined with any other embodiment, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects and embodiments disclosed herein.

References to “or” may be construed as inclusive so that any terms described using “or” may indicate any of a single, more than one, and all of the described terms. Intervening embodiments, acts, or elements are not essential unless recited as such. Any solution to a problem, or any element or act presented herein in the alternative, for example using the word “or,” is neither ambiguous nor indirect simply because it may be presented in the alternative. Any such alternative embodiments, solutions, elements, or acts are derivable directly and unambiguously as at least one embodiment independent of any other alternative solutions, elements, or acts, and independent of any intervening solutions, elements, or acts.

Where technical features in the drawings, detailed description or any claim are followed by references signs, the reference signs have been included for the sole purpose of increasing the intelligibility of the drawings, detailed description, and claims. Accordingly, neither the reference signs nor their absence have any limiting effect on the scope of any claim elements.

One skilled in the art will realize the systems and methods described herein may be embodied in other specific forms without departing from the spirit or essential characteristics thereof. For example, the handheld electronic device grip may secure devices in general, and is not limited in use to electronic devices. Further, subsequent to disposing at least one finger in the opening of the loop, the user may release his or her finger from loop at will without damaging the handheld electronic device grip or any attachments between the loop, the mounting structure and the handheld electronic device or its case. Further, it is appreciated that attaching the mounting structure to the back side of the handheld electronic device and attaching the mounting structure to a case that covers at least part of the back side of the handheld electronic device are interchangeable. Any references (e.g., attachments or positional orientations) relative to the back side of the handheld electronic device include an equivalent reference to attachments or positional orientations with a case covering at least part of the back side. For example, the mounting structure can attach to the back side of the handheld electronic device, its case, or simultaneously to both the handheld electronic device and its case. In another example, description of angular orientations with respect to the back side of the handheld electronic device include an equivalent angular orientation to any case covering at least part of the back side of the handheld electronic device, irrespective of any alignment or positional arrangement between the handheld electronic device and its case. In one embodiment, the handheld electronic device grip includes at least one loop configured to receive at least one finger disposed therein, and at least one mounting structure can attach to the at least one loop and the handheld electronic device, its case, or a combination thereof. While the Figures may illustrate an opening in the loop in the absence of at least one finger being disposed through the loop, the loop can collapse due to gravitational forces when the finger is not present and the loop includes elastic, cloth, or other collapsible material.

The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A handheld electronic device grip, comprising:
a loop configured to receive at least one finger of a user; and
a mounting structure configured to attach the loop to at least one of a handheld electronic device and a handheld electronic device case, the mounting structure being configured to orient the loop so that a central axis of an opening of the loop is generally transverse to a longitudinal direction of the at least one of the handheld electronic device and the handheld electronic device case.

2. The handheld electronic device grip of claim 1, wherein the loop comprises:
an outer surface and an inner surface, at least a first portion of the outer surface configured to engage the mounting structure, and the inner surface configured to receive the at least one finger of the user.

3. The handheld electronic device grip of claim 2, wherein the mounting structure comprises:
a first surface configured to releasably adhere to at least one of the handheld electronic device and the handheld electronic device case; and
a second surface configured to engage the first portion of the outer surface of the loop.

4. The handheld electronic device grip of claim 2, wherein the mounting structure comprises:
a first surface configured to permanently adhere to at least one of the handheld electronic device and the handheld electronic device case; and
a second surface configured to engage the first portion of the outer surface of the loop.

5. The handheld electronic device grip of claim 2, wherein the outer surface of the loop includes a first portion of a hook and loop fastener system, and wherein the mounting structure includes a second portion of the hook and loop fastener system.

6. The handheld electronic device grip of claim 1, wherein the mounting structure comprises:
a first mounting structure portion configured for placement on a first portion of at least one of the hand held electronic device and the handheld electronic device case; and
a second mounting structure portion configured for placement on a second portion of at least one of the hand held electronic device and the handheld electronic device case.

7. The handheld electronic device grip of claim 6, wherein the loop comprises a first loop configured to attach to the first mounting structure portion, further comprising:
a second loop configured to attach to the second mounting structure portion.

8. The handheld electronic device grip of claim 1, wherein the loop comprises a first loop, further comprising:
a second loop configured to attach to a second mounting structure.

9. The handheld electronic device grip of claim 7, wherein the first mounting structure portion is configured for placement adjacent to the second mounting structure portion.

10. The handheld electronic device grip of claim 7, wherein the first mounting structure portion is configured for placement distal to the second mounting structure portion.

11. The handheld electronic device grip of claim 7, wherein the first loop and the second loop are configured on the mounting structure to receive the at least one finger of the user.

12. The handheld electronic device grip of claim 7, wherein the first loop is configured on the mounting structure to receive the at least one finger of the user, and the second loop is configured on the mounting structure to receive a second finger of the user.

13. The handheld electronic device grip of claim 1, wherein the loop comprises a first loop, the handheld electronic device grip further comprising:
a second loop having an inner surface and an outer surface, a first portion of the outer surface of the second loop configured to attach to the mounting structure.

14. The handheld electronic device grip of claim 13, wherein the first loop and the second loop are configured on the mounting structure to receive the at least one finger of the user.

15. The handheld electronic device grip of claim 13, wherein the first loop is configured on the mounting structure to receive the at least one finger of the user, and the second loop is configured on the mounting structure to receive a second finger of the user.

16. The handheld electronic device grip of claim 1, wherein the mounting structure comprises at least one of a rectangular shape, a quadrilateral shape, a polygonal shape, an equilateral shape, an asymmetrical shape, and an elliptical shape.

17. The handheld electronic device grip of claim 1, wherein the loop includes at least one of an elastic loop, a collapsible loop, a spring mounted loop, a rigid loop, a cloth loop, a cylinder, an oval, an ellipse, a tube, a sleeve, and a strap.

18. The handheld electronic device grip of claim 1, wherein the loop has a diameter of less than 2 cm and a longitudinal length of at least 1 mm.

19. The handheld electronic device grip of claim 1, wherein the loop is configured on the mounting structure as an ellipse having a major axis of less than 12 cm and a minor axis of less than 6 cm when the at least one finger is positioned in the opening of the loop.

20. The handheld electronic device grip of claim 19, wherein an inner surface of the loop is configured with a plurality of concave grooves extending longitudinally along the central axis of the opening of the loop.

21. The handheld electronic device grip of claim 1, wherein the loop is configured substantially in parallel with a longitudinal axis of the handheld electronic device, the opening of the loop having a central axis that is substantially perpendicular to the longitudinal axis of the handheld electronic device.

22. The handheld electronic device grip of claim 21, wherein the loop is configured to pivot between a first position parallel to the longitudinal axis of the handheld electronic device and a second position parallel to the longitudinal axis of the handheld electronic device.

23. The handheld electronic device grip of claim 1, wherein the handheld electronic device grip is configured to permanently attach to the handheld electronic device.

24. The handheld electronic device grip of claim 1, wherein the handheld electronic device grip is configured to releasably attach to the handheld electronic device.

25. The handheld electronic device grip of claim 1, wherein the loop is an integral part of the mounting structure.

26. The handheld electronic device grip of claim 1, wherein at least one of the loop and the mounting structure form part of the handheld electronic device case.

27. The handheld electronic device grip of claim 1, wherein the loop is configured to position a hand of the user so that a thumb of the hand is positioned to manipulate substantially all of a user interface of the handheld electronic device when the at least one finger is positioned in the loop.

28. The handheld electronic device grip of claim 1, wherein the central axis is within 45 degrees of a perpendicular axis to the longitudinal direction of the at least one of the handheld electronic device and the handheld electronic device case.

29. A handheld electronic device grip, comprising:
means for:
configuring a loop to receive at least one finger of a user; and
attaching the loop to at least one of a handheld electronic device and a handheld electronic device case, wherein a central axis of an opening of the loop is generally transverse to a longitudinal direction of the at least one of the handheld electronic device and the handheld electronic device case.

30. A method of connecting a handheld electronic device grip to a handheld electronic device, the handheld electronic device grip having a mounting structure and a loop, the method comprising:
attaching the mounting structure to at least one of the handheld electronic device and a handheld electronic device case; and
attaching the loop to the mounting structure; and
orienting the loop so that a central axis of an opening of the loop is generally transverse to a longitudinal direction of the at least one of the handheld electronic device and the handheld electronic device case.

31. A method of securing a handheld electronic device, comprising:
providing a handheld electronic device grip, the handheld electronic device grip including a loop configured to receive at least one finger of a user, and a mounting structure configured to attach the loop to at least one of a handheld electronic device and a handheld electronic device case, the mounting structure being configured to orient the loop so that a central axis of an opening of the loop is generally transverse to a longitudinal direction of the at least one of the handheld electronic device and the handheld electronic device case.

32. The method of claim 31, comprising:
providing instructions to assemble the handheld electronic device grip, the instructions including at least one instruction directing a user to attach the mounting structure to at least one of the handheld electronic device and the handheld electronic device case.

33. The method of claim 31, comprising:
providing instructions to assemble the handheld electronic device grip, the instructions including at least one instruction directing a user to attach the loop to the mounting structure.

34. The method of claim 31, comprising:
providing instructions to assemble the handheld electronic device grip, the instructions including at least one instruction directing a user to orient the loop so that the central axis of the opening of the loop is generally transverse to the longitudinal direction of the at least one of the handheld electronic device and the handheld electronic device case.
